(19) United States
(12) Patent Application Publication
(10) Pub. No.: US 2009/0224877 A1
(43) Pub. Date: Sep. 10, 2009

(54) SYSTEM AND METHOD FOR RADIO CONTROLLED GATE AND GATE STATUS

(75) Inventor: Wayne Skeem, Twin Falls, ID (US)

Correspondence Address: THORPE NORTH & WESTERN, LLP., P.O. Box 1219, SANDY, UT, 84091-1219, US

(73) Assignee: SIREN OPERATED SENSORS, INC., Twin Falls, ID (US)

(21) Appl. No.: 12/042,270

(22) Filed: Mar. 4, 2008

(51) Int. Cl. G05B 19/00

(52) U.S. Cl. 340/5.71

(57) ABSTRACT

The invention provides a system for remotely actuating barrier systems using an audio tone. A first two-way radio communication device can be used to send the audio tone to a second two-way radio communication connected to an interface circuit. The interface circuit can be operably connected to a gate controller that can be used to actuate a barrier system. The interface circuit can activate a first recorded message when the barrier is moving in a first direction and a second recorded message when the barrier is moving in a second direction. The first and second recorded messages can be transmitted by the second two-way radio to the first two way radio, enabling a user to determine if the barrier is opening or closing.

### FIELD OF THE INVENTION

The present invention relates generally to electronic control of automated gates. More particularly, the present invention relates to remote control of automated gates.

### BACKGROUND

Systems for remote actuation of equipment, such as barrier movement equipment, are common today. Usually, remotely controlled barrier movement systems include a wireless receiver which can respond to a security code conveyed by a transmitter. For example, most homes now come equipped with an automatic garage door that can be actuated through the use of a transmitter placed in a homeowner's automobile.

Similarly, gates used by multiple people can be equipped with remote barrier movement systems to enable users, such as people living in a private neighborhood, to open the gate by transmitting a code. A gate that is used by a number of people, however, can be much more expensive to remotely actuate. In the example above, a neighborhood gate may be used by dozens or even hundreds of different car owners living in the neighborhood. Each car owner in the neighborhood can require a transmitter to actuate the gate. The cost of purchasing separate transmitters for each car owner in the neighborhood can be prohibitively expensive. This can also be true of camp grounds, ranches, oil fields, and other locations where a plurality of people may each need access to private land controlled by a gate.

Most remotely controlled barrier movement systems are designed to operate within a short range of the receiver, usually less than 100 feet. In rural locations, however, it maybe desirable to operate a gate from a substantial distance. For example, a camp ground operator may wish to actuate a gate located near a main road. A typical transmitter/receiver used to remotely operate a gate would likely have too limited a range to function for such a purpose. Further, in public access locations such as a campground, it may be convenient for the paying public to be able to operate a remote gate without purchasing or renting a specialized transmitter. This would allow persons who have rented a camping spot within the campground to enter and leave the campground at their convenience, without the trouble of obtaining specialized transmitters that may be broken or lost.

What is needed is a method for remotely operating a barrier movement system a substantial distance from the barrier, without necessarily requiring a specialized transmitter.

### SUMMARY OF THE INVENTION

The invention provides a system for remotely actuating barrier systems using an audio tone. A first two-way radio communication device can be used to send the audio tone to a second two-way radio communication connected to an interface circuit. The interface circuit can be operably connected to a gate controller that can be used to actuate a barrier system. The interface circuit can activate a first recorded message when the barrier is moving in a first direction and a second recorded message when the barrier is moving in a second direction. The first and second recorded messages can be transmitted by the second two-way radio to the first two way radio, enabling a user to determine if the barrier is opening or closing.

### BRIEF DESCRIPTION OF THE DRAWINGS

FIG. 1 is block diagram in accordance with an embodiment of the present invention;

FIG. 2 is schematic showing an embodiment of an interface circuit card of the present invention; and

FIG. 3 is a flow chart depicting a method for remotely actuating a moveable barrier using an audio tone in accordance with an embodiment of the present invention.

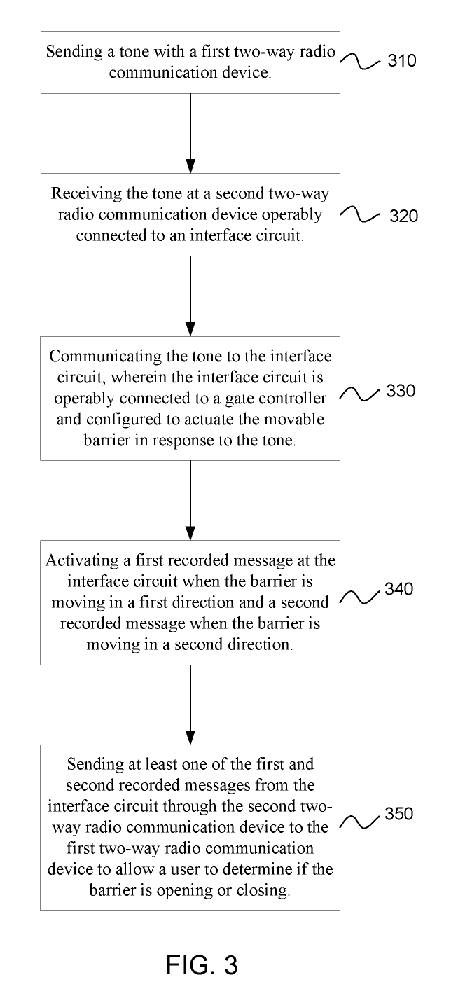

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

At locations where access to public or private land is controlled by a gate or other barrier system, it can be convenient for those with access to be able to operate the barrier system remotely without purchasing or renting a specialized transmitter. For example, at a campground it would be convenient to allow persons who have rented a camping spot within the campground to enter and leave the campground at their convenience, without the hassle and risk of obtaining specialized transmitters that may be broken or lost.

In order to overcome the problems described and to provide an inexpensive and efficient method for remotely actuating a barrier system, the present invention provides a system and method for remotely actuating a barrier system. Rather than require each person with access to a gate to obtain a specialized transmitter, it can be convenient to develop a system for remotely actuating a gate, wherein the system can use a publicly available means for transmission of the remote signal. One means for controlling the gate can be the use of a publicly available radio transmitter to transmit a signal to a remotely controlled gate. For example, a radio operating on the Family Radio Services (FRS) or General Mobile Radio Service (GMRS) standard can be used to transmit a signal to open or close a remote gate. Other types of radios that are configured to communicate under the personal radio service and personal communication service bands, as designated by the federal communications commission, are also considered to be within the scope of the present invention.

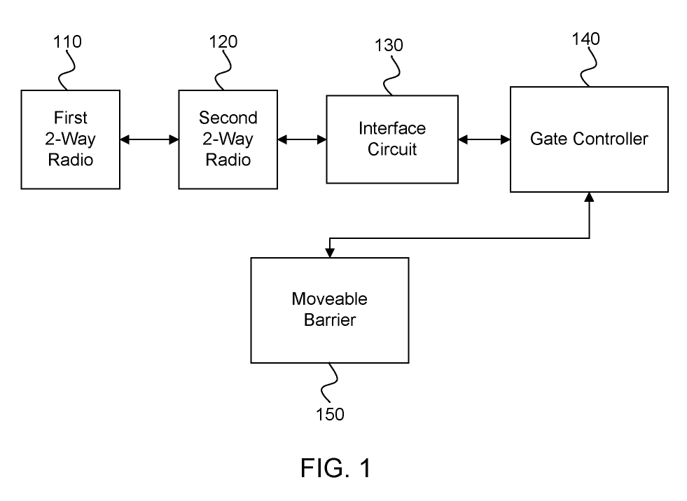

An FRS radio can be used to transmit a signal for a distance of up to 2 miles, depending upon the geography of the land. A GMRS radio can transmit up to 5 miles. In the present invention, a first two-way radio 110 such as the FRS or GMRS radio can be used to transmit a tone to a second two-way radio 120, as shown in FIG. 1. The second radio can be connected to an interface circuit 130. The interface circuit, which will be discussed more fully below, can be used to receive the tone received by the second radio and activate a gate controller 140. The gate controller can then be used to open and close a moveable barrier 150 such as a gate.

Due to the range of the radio, it can be beneficial to detect whether the gate is opening or closing, as well as whether the gate reverses its direction due to an object in the path of the gate. Many gates are able to sense an object and reverse direction. Some gates are also equipped with detectors able to detect if something is in the path of the gate. In one embodiment of the present invention, the interface circuit 130 can sense whether the gate is opening or closing. An audible signal can be transmitted from the second radio back to the first radio to enable the user to be aware of the gates movement.

In one embodiment, the interface circuit 130 can generate a first tone signaling that the gate is opening and a second tone signaling that the gate is closing. The tones may be of different pitch, or they may be of the same pitch and have differing intermittent periods. In one embodiment, a change in the direction of the gate's movement can be detected at the interface circuit as a reverse in polarity from the gate controller 140. The interface circuit can detect the change in polarity and generate the second tone in response to the change in polarity. The interface circuit can communicate the tones to the second two-way radio 120, which can then automatically transmit the tones to the first two-way radio 110 whenever the gate is moving.

In order to provide security, the FRS/GMRS radios 110 and 120 can be set to a plurality of channels, with each channel having a plurality of differing codes. Each code can act as a virtual channel, allowing a user to talk privately to another radio using the same channel and code. A typical radio can provide up to 830 different channel and code combinations. Thus, a gate owner can set the FRS/GMRS radio at the gate to a specific channel and code. Only those that are informed of the correct channel and code will be able to operate the gate. The person in charge of the gate can be made aware of the gate's operation by having an FRS/GMRS radio tuned to the same channel as the radio connected to the gate controller. Whenever the gate is actuated, the opening or closing tone can be transmitted to the person in charge.

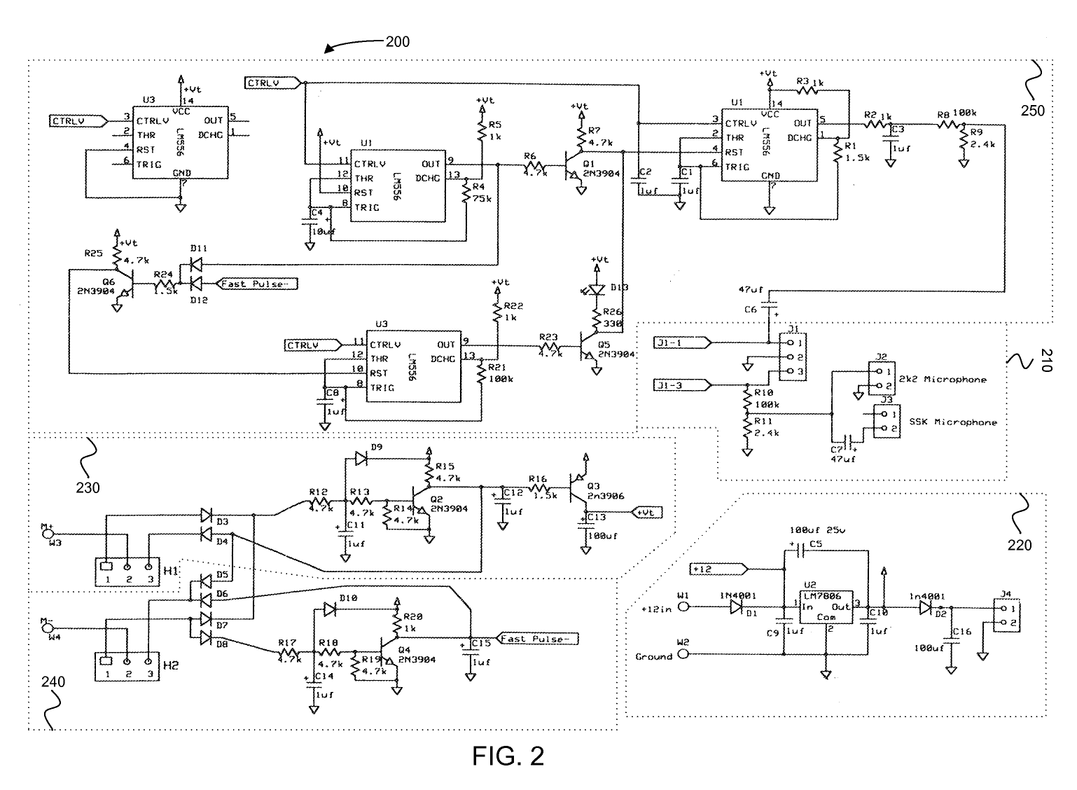

One embodiment 200 of the interface circuit 130 is shown in the schematic of FIG. 2. This embodiment enables a modulated tone to be transmitted from the second communication device 120 to the first communication device 110 based upon the movement of the gate 150. The modulation frequency of the tone enables a user to determine whether the gate is opening or closing. An explanation of the circuit shown in FIG. 2 follows. The explanation is not meant to limit the design of the interface circuit, only to show one possible configuration.

The interface circuit 200 can be composed of 4 main sections.

1. The first section 210 is a simple circuit to Remove DC Bias and reduce signal strength from the Speaker output of the radio. The audio output from the microphone/speaker jack of the radio can be connected to J1-3. Resistors R10 and R11 can be used to reduce the power of the radio's audio output. A signal can then be sent to a gate controller to actuate the gate. Additional signal conditioning on the signal may be performed prior to sending it to a gate controller. Other circuit cards may be used to manipulate the signal at J1-3 such that it can be used to operate a variety of gate controllers and other electrical and mechanical devices upon reception of a predetermined tone from the radio's audio output. The J1-1 connection can be connected to the microphone/speaker jack of the radio to transmit a gate opening or closing audio signal through the radio to a user, enabling the user to detect whether the gate was opening or closing. C7 is a filter Capacitor.

2. The second section 220 is a simple linear power supply. Positive DC power is applied to Connection W1. DC Common is applied to Connection W2, referred to as ground. D1 is a Diode used to protect against reverse polarity. Capacitors C9, C5, and C10 are used to filter high frequency feedback from linear regulator U2 and the radio. D2 is used to reduce the charging voltage to the Radio Batteries and also to block reverse power flows from the Radio to the interface circuit 200. C16 is a filter Capacitor.

3. The third section is the sense input section. It is composed of two similar sections, 230 and 240, one for each monitored signal.

Section 230 starts at connection W3, also labeled M+(Motor+). The signal from W3 is routed through Header H1 which is used to select an Active Signal Level, either positive or ground. If the chosen Active Signal Level is positive, then H1 is set in such a way as to route the signal through D3 to R12, at which point C11 acts to filter out short duration transients. D9 is used to clip the input maximum voltage to VCC +0.7 v. R13 is used to reduce the signal current passed to the base of transistor Q2. R14 is used to turn off Q2 when no signal is present. Q2 is used to conduct current through resistor R15 if a signal is present. This acts to bring the voltage at the Collector of Q2 from its standby value of Vcc to a value approaching ground. This is also the point at which a Ground Active Signal is inserted from H1. In either case of a high active signal routed through Q2 or a low active signal from H1 through D4, the low level signal at R16 filtered by C12 activates Transistor Q3 which supplies power for the oscillator section 250.

Section 240 starts at connection W4, also labeled M− (Motor−). The signal from W4 is routed through Header H2 which is used to select the Active Signal Level, which is either positive or ground. If the chosen active signal level is positive, H2 is set in such a way as to route the signal through both D7 and D8. The signal through D7 is connected to R12 to initiate power up (see section 230). The signal through D8 is used to activate the Transistor Q4 to generate an inversed signal level which is called “Fast Pulse-”. This signal can be used for controlling input for the oscillator section 250. If H2 is selected for a Ground active signal, the signal is routed through Diodes D5 and D6. The signal through D5 is connected to R16 to Initiate Power up (See section 230). The part of the signal routed through D6 is passed directly as the “Fast Pulse-” controlling input to the oscillator section 250.

4. The fourth section 250 is referred to as the oscillator section and is comprised of three timer circuits built around NE555 timer IC's. The actual implementation of the design uses NE556 devices which are Dual 555 devices in one IC. In the diagram, the NE 556 is referred to as U1 part A and U1 part B to distinguish the multiple devices.

The following explanation starts at the output stage and works backwards. When an active signal from the gate controller is applied to either W3 or W4 (representing a gate opening or a gate closing), power up is initiated. Power up starts an alternating charge and discharge cycle which is applied by U1 part A to C1. R1 and R3 set the frequency of the oscillation. U1 Pin 5 is the output signal which is converted from a square wave signal to a modified sawtooth by resistor R2 and capacitor C3. Resistor R8 and R9 are used to reduce the signal level. Capacitor C6 removes the DC bias from the output signal.

The next stage backwards is referred to as the long pulse stage. It is also built around a NE555 Timer IC. When power up is initiated, U1 part B forms an oscillator. Values of Capacitor C4 and Resistors R4 and R5 can then be chosen to set the oscillator period to about 1 second. The output of U1 part b is Pin 9 which is inverted by Resistor R6, Transistor Q1, Resistor R7 and applied to the Reset input of the Output stage, causing U1 part A to turn off creating a slow beat of silence in its output.

The next stage is referred to as the fast pulse stage. It is also built around a NE555 Timer IC. This stage is controlled by both the output of U1 part b and the “Fast Pulse-” signal from W4. Diodes D11 and D12 form the input stage of a NAND gate built of Resistors R24 and R25, and Transistor Q6. This NAND gate is used to control the oscillation of U3 part B. This oscillation period is set to ⅓ of the period of U1 part b by the values of Capacitor C8, and Resistors R21, and R22. The output of this stage is inverted by Resistors R23, R26, and Transistor Q5. D13 is a light emitting Diode used to provide a visual queue of operations. The inverted signal is OR'd with the inverted output of U1 part b to cause a fast beat of silence in the output stage U1 part A.

The fast beat of silence and the slow beat of silence can be used to interrupt a constant audio tone, thus producing two distinguishable tones that can be transmitted to the radio through J1-1, depending upon the polarity of W3 and W4. The fast beat and slow beat signals can then be transmitted by the radio connected to the interface circuit 200 to the radio operated by the user, allowing the user to receive a first audio signal that the gate is opening and a second audio signal that the gate is closing. The signal sent to the radio connected to the interface circuit can automatically activate the radio's voice activated transmission, allowing the radio to broadcast for the length of the audio tone.

The interface circuit 200 can be used to provide a charge for rechargeable batteries used in an FRS/GMRS radio, thus enabling the radio connected to the interface circuit to be used indefinitely.

In another embodiment, a recorded message can be generated at the interface circuit 130 (FIG. 1). The recorded message that is generated can be based on the movement of the gate or barrier 150. For example, a first recorded message such as “the gate is opening” can be generated when an appropriate signal is received at the interface circuit from the gate controller 140. Another recorded message such as “the gate is closing” can be generated when a signal is received from the gate controller that corresponds to a closing gate. Additional recorded messages may also be included, such as “the gate is blocked”, “the gate is locked”, “the gate is already open”, and “the gate is already closed”, and so forth.

In one embodiment, a tone can be generated from the first two-way radio 110. The second two-way radio 120 can be connected to the interface circuit 130, as previously discussed. The tone from the first two-way radio can be received at the second two-way radio and communicated to the interface circuit. The interface circuit can then communicate a signal to the gate controller 140. The gate controller can then activate the gate and close or open the gate, depending upon its initial state. An appropriate recorded message can be generated at the interface circuit and sent to the second two-way radio, which can be activated using the radio's voice activated transmission. In one embodiment, the recorded message can be generated a single time for each tone that is received from the first two-way radio. Alternatively, the recorded message can be repeated a desired number of times. For example, the recorded message may be continuously repeated as long as the gate or barrier 150 is actively moving.

Any type of electrical circuit capable of storing a recorded message can be used in conjunction with the interface circuit 130. For example, a chip from the ISD1900 series of microchips from Winbond can be used in conjunction with the interface circuit and the gate controller 140 to generate recorded messages based on the action of the gate. In one embodiment, a positive signal from the gate controller can be communicated to the interface circuit and activate a desired message from the ISD1900. A negative signal from the gate controller can generate another message from the ISD1900. Additional signals from the gate controller, such as a signal that a gate is locked or blocked, can enable further messages to be generated by the ISD1900. These messages can be communicated to the microphone/speaker jack of the second two-way radio 120. The recorded messages sent to the second radio connected to the interface circuit can automatically activate the radio's voice activated transmission, allowing the radio to broadcast for the length of the recorded message. This will allow the second radio to transmit a gate opening or gate closing recorded message to the first two-way radio 110, enabling the user to determine whether the gate was opening or closing even when the gate is not within view.

The system may also be used for a wider variety of uses than just opening a gate or barrier. A second tone received shortly after a first tone can instruct the interface circuit to turn on lights by the gate, activate a camera, a monitor, or another type of electronic device. For example, a campground operator can send a first and second tone to a gate to activate a camera, enabling the operator to view the gate and persons entering or exiting the gate. In another embodiment, a monitor may be activated that allows detailed information to be displayed. For example, the monitor may display detailed information regarding assigned camping locations, costs, and other campground information. Other types of electronic devices may also be activated using a single tone or a plurality of tones, as can be appreciated.

Another embodiment of the present invention provides a method 300 for remotely actuating a moveable barrier using an audio tone. The method includes the operation of sending 310 a tone with a first two-way radio communication device and receiving 320 the tone at a second two-way radio communication device operably connected to an interface circuit. An additional operation includes communicating 330 the tone to the interface circuit, wherein the interface circuit is operably connected to a gate controller and configured to actuate the movable barrier in response to the tone. Another operation provides for activating 340 a first recorded message at the interface circuit when the barrier is moving in a first direction and a second recorded message when the barrier is moving in a second direction. An additional operation includes sending 350 at least one of the first and second recorded messages from the interface circuit through the second two-way radio communication device to the first two-way radio communication device to allow a user to determine if the barrier is opening or closing.

The use of a recorded message to inform the user about a movement of a barrier such as a gate can provide a more direct and accurate means to inform the user. The recorded message can reduce or eliminate accidental actuations of the gate and better inform the user as to the gate's status. Using the previous examples of a gate located at a campground, a campground user may not understand whether a modulated tone means that the gate is opening or closing. However, the recorded message can inform the campground user, allowing them to open and close the gate from a remote location prior to their entrance to or exit from the campground.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A system for remotely actuating a barrier using an audio tone, comprising:
a first two-way radio communication device;
a second two-way radio communication device operably connected to an interface circuit;
the interface circuit being operably connected to a gate controller and configured to activate a first recorded message when the barrier is moving in a first direction and a second recorded message when the barrier is moving in a second direction; and
the second two-way radio communication device configured to receive the first and second recorded messages from the interface circuit and transmit the first and second recorded messages to the first two-way radio communication device, wherein the first and second recorded messages allow a user to determine if the barrier is opening or closing.

2. A system as in claim 1, wherein the first and second two-way communication devices are selected from the group consisting of FRS radios and GMRS radios.

3. A system as in claim 1, wherein the first and second two-way communication devices are configured to communicate on one of a personal radio service and a personal communication service band, as designated by the federal communications commission.

4. A system as in claim 2, wherein the radios are configured to operate on a plurality of different channels, with each channel having a plurality of different codes.

5. A system as in claim 1, further comprising the interface circuit further configured to activate an electronic device when one or more tones are received from the first two-way radio communication device.

6. A system as in claim 5, wherein the electronic device is selected from the group consisting of a light, a camera, and a monitor.

7. A method for remotely actuating a moveable barrier using an audio tone, comprising:
sending a tone with a first two-way radio communication device;
receiving the tone at a second two-way radio communication device operably connected to an interface circuit;
communicating the tone to the interface circuit, wherein the interface circuit is operably connected to a gate controller and configured to actuate the movable barrier in response to the tone;
activating a first recorded message at the interface circuit when the barrier is moving in a first direction and a second recorded message when the barrier is moving in a second direction; and
sending at least one of the first and second recorded messages from the interface circuit through the second two-way radio communication device to the first two-way radio communication device to allow a user to determine if the barrier is opening or closing.

8. A method as in claim 7, further comprises sending the tone with the first two-way radio communication device and receiving the tone at the second two-way radio communication device, wherein the first and second two-way radio communication devices are selected from the group consisting of FRS radios and GMRS radios.

9. A method as in claim 7, further comprises sending the tone with the first two-way radio communication device and receiving the tone at the second two-way radio communication device, where in the first and second two-way radio communication devices are configured to communicate on one of a personal radio service and a personal communication service bands as designated by the federal communication commission.

10. A method as in claim 7, further comprising communicating a selected channel and a predetermined code to the user to enable the user to configure the first two-way radio communication device to operably communicate with the second two-way radio communication device at the selected channel using the predetermined code to allow the user to actuate the barrier with the first two-way radio communication device.

11. A method as in claim 7, further comprising configuring the interface circuit to actuate an electronic device when one or more tones are received from the first two-way radio communication device.

12. A method as in claim 11, further comprising actuating the electronic device when one or more tones are received from the first two-way radio communication device, wherein the electronic device is selected from the group consisting of a light, a camera, and a monitor.
